(19) United States
(12) Patent Application Publication
(10) Pub. No.: US 2026/0022606 A1
(43) Pub. Date: Jan. 22, 2026

(54) DOOR LEAF AS WELL AS A DOOR SYSTEM

(71) Applicant: ASSA ABLOY ENTRANCE SYSTESMS AB, LANDSKRONA (SE)

(72) Inventor: Peter TSCHANZ, Gerlikon (CH)

(21) Appl. No.: 18/993,116

(22) PCT Filed: Jul. 12, 2023
(86) PCT No.: PCT/EP2023/069328

§ 371 Date: Jan. 10, 2025

(30) Foreign Application Priority Data
Jul. 14, 2022 (SE) 2230240-0

(51) Int. Cl. E06B 3/46; E06B 7/23

(52) U.S. Cl. CPC E06B 3/4681; E06B 7/2316

(57) ABSTRACT

A door leaf (14) for a door system (10) has a main component (24), a carrier profile (26) and a strap (28). The main component (24) has an upper end face, a front end face, a lower end face and a rear end face, wherein the carrier profile (26) is attached to the upper end face. The strap (28) has a first end (38) and a second end (40), wherein the strap (28) is attached to the carrier profile (26) with the first end (38), subsequently extends along the front end face, the lower end face and the rear end face of the main component (24) and is subsequently attached to the carrier profile (26) with the second end (40).

Further, a door system (10) is shown.

The invention relates to a door leaf for a door system as well as a door system.

Automatic door systems, in particular sliding doors are well known in the art. Typically, door leaves of a sliding door are mounted in a door header at the upper side of the door.

Further, such door leaves comprise large main component for design purposes, in particular a single large glass element. The large main component has to be securely supported over the whole lifetime of the door leaf. It is known to provide a rigid frame for the main component, encompassing the main component along all of its end faces to securely support the main component.

The frame has to have a certain thickness in the length or height direction to bear the weight of the main component. Thus, the frame contributes a considerable amount of material apart from the main component and increases the assembly time and costs. Further, as the frame has to have the certain thickness, the frame as to have an optical pleasing appearance, i.e. it needs to be painted, further increasing the costs of the door leaf.

It is therefore the object of the invention to provide a door leaf as well as a door system that can be manufactured with less material, lower assembly costs but without compromising the longevity.

For this purpose, a door leaf for a door system comprising a main component, a carrier profile and a strap is provided. The main component has an upper end face, a front end face, a lower end face and a rear end face, wherein the carrier profile is attached to the upper end face. The strap has a first end and a second end, wherein the strap is attached to the carrier profile with the first end, subsequently extends along the front end face, the lower end face and the rear end face of the main component and is subsequently attached to the carrier profile with the second end.

The inventors have realized that only one carrier profile at the upper end face of the main component is necessary, which carries the main component. In order to provide the necessary safety and longevity of the door leaf, the main component is additionally secured with a strap encompassing the main component.

Therefore, a weight-bearing frame along all sides of the main component is not necessary anymore, reducing the material needed for the door leaf as well as the assembly costs. Thus, the door leaf may be free of a rigid frame encompassing the main component.

For example, the upper end face and the lower end face extend orthogonal to the height direction. The front end face and the rear end face may extend orthogonal to the length direction.

In particular, the front end face corresponds to a main closing edge of the door leaf, and the rear end face corresponds to a secondary closing edge of the door leaf.

In an aspect, the first end is attached in the quarter of the length of the carrier profile abutting the front end face of the carrier profile and/or the second end is attached to the carrier profile in the quarter of the length of the carrier profile abutting the rear end face of the carrier profile.

In an embodiment, the main component is attached to the carrier profile by an adhesive connection, in particular wherein the adhesive connection is capable of carrying the whole weight of the main component. An adhesive can be applied without tools, reducing manufacturing costs.

The adhesive connection may be made by an adhesive and/or extends in particular fully along the upper end face of the main component.

In particular, the strap is not necessary for holding the main component against gravity.

In an aspect, the door leaf comprises at least one tensioning mechanism attached to the carrier profile, wherein the strap is connected to the carrier profile via the at least one tensioning mechanism. The tensioning mechanism further simplifies the assembly, as a tensioning tool is not necessary.

For example, the tensioning mechanism comprises a spool in which the respective end of the strap is inserted, in particular wherein the spool has engagement teeth for engaging with a stop fixed relative to the carrier profile, providing a simple and efficient means for tensioning the strap.

In order to avoid damage to the strap, the strap may extend along the front end face, the lower end face and/or the rear end face spaced apart by a distance from the respective end face.

In an embodiment, the door leaf comprises at least one spacer located between the strap and one of the end faces of the main component so that the course of the strap can be determined precisely.

For example, the at least one spacer is located at the front end face or the rear end face of the carrier profile and extends downwards partly along the respective end face of the main component and/or wherein the spacer is engaged with the carrier profile, further simplifying the assembly.

A portion of the spacer may comprise a stop for the engagement teeth of the spool.

For reducing the strain on the strap, the at least one spacer may extend across the edge of the lower end face of the main component with the front end face and/or with the rear end face of the main component, particularly the spacer abutting the respective end faces of the main component. The strap may run at the outside of the spacer.

In an embodiment, the door leaf comprises at least one utility profile, in particular three utility profiles, the at least one utility profile being attached to the front end face, the lower end face or the rear end face of the main component, in particular by an adhesive connection. The utility profile allows to attach components to the door leaf, like a seal or a wing.

The utility profile may also extend along end face of the carrier profile.

For example, the utility profile attached to the front end face comprises at least one receptacle for receiving a seal of the door leaf, in particular wherein the utility profile comprises two receptacles, each for one seal. This way, the main closing edge can be provided with a seal easily.

The seals and/or receptacles may extend in length direction and the seals and/or receptacles are spaced apart in the width direction.

In particular, the seals extend along the entire main component in the height direction.

In an aspect, the utility profile attached to the rear end face comprises a receptacle for a brush or seal facing in the width direction and/or comprises a wing extending in the length direction partly along the main component, increasing the thermal insulation properties of the door leaf.

A mount for a seal may be present in utility profile between the wing and the door component in the width direction.

In an embodiment, the utility profile attached to the lower end face of the main component comprises a sword extending downward, providing a cost efficient way of equipping the door leaf with a sword.

In order to further reduce manufacturing costs, the at least one utility profile may be made of plastics.

The strap may have a smaller width than the main component reducing the costs further.

In an aspect the carrier profile and/or the utility profile has the same width as the main component, allowing for a wider main component.

In an embodiment, the main component is a glass element, in particular an insulating glass element.

The glass element has a cavity filled with gas, further improving the thermal insulation properties. Argon may be used as the gas, reducing the costs compared to the use of Krypton.

For above mentioned purpose, a door system is further provided. The door system comprises a door leaf as described above, in particular wherein the door system comprises a door header and the carrier profile is located in the door header, at least partly, in particular fully.

The features and advantages discussed with respect to the door leaf also apply to the door system and vice versa.

Further features and advantages will be apparent from the following description as well as the accompanying drawings, to which reference is made. In the drawings:

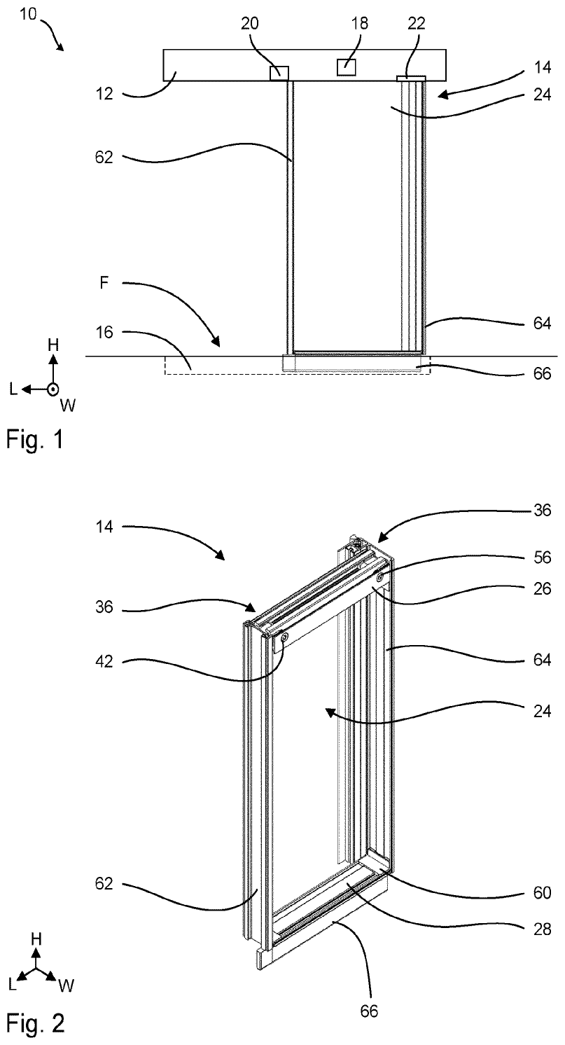

FIG. 1: shows a side view of a door system according to the invention having a door leaf according to the invention,

FIG. 2: shows a perspective view of the door leaf of FIG. 1,

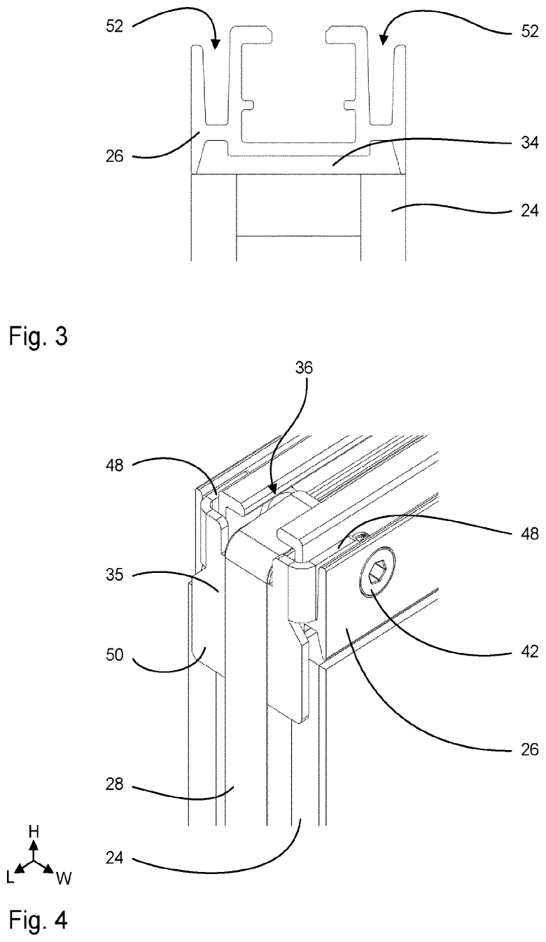

FIG. 3: shows a sectional view of a carrier profile and a main component of the door leaf of FIG. 2,

FIG. 4: shows a perspective view of the upper front edge of the door leaf of FIG. 2,

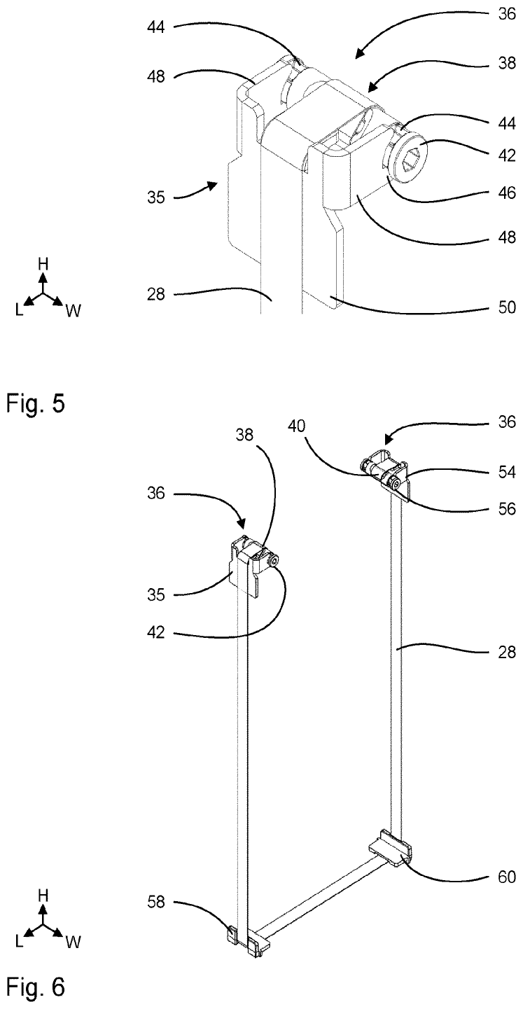

FIG. 5: shows part of a strap, a spacer and a tightening mechanism in an enlarged view of FIG. 4,

FIG. 6: shows the entire strap of the door leaf of FIG. 2 without the main component,

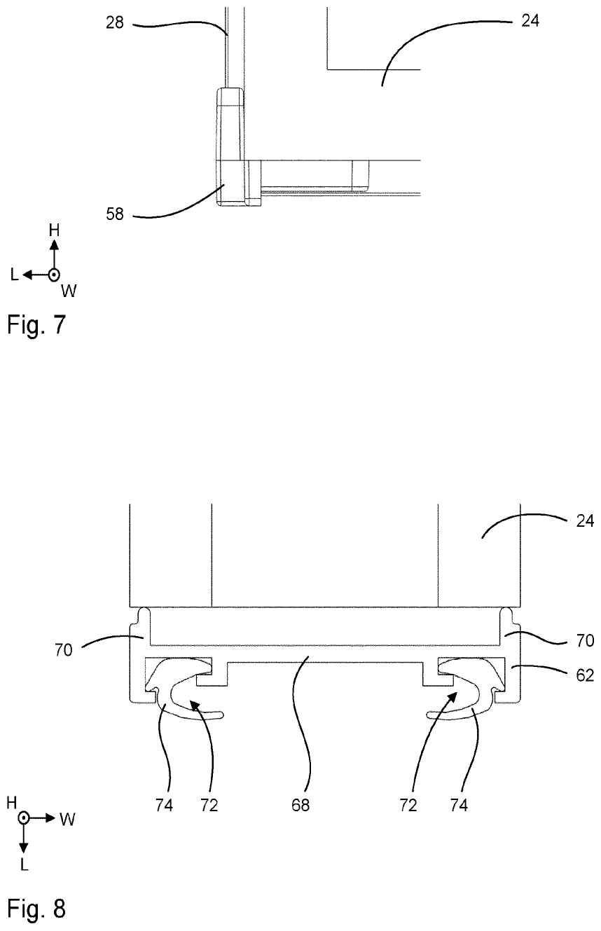

FIG. 7: shows the lower front edge of the door leaf of FIG. 2 in an enlarged view without utility profiles,

FIG. 8: shows a sectional view through the utility profile at the front end face of the door leaf of FIG. 2,

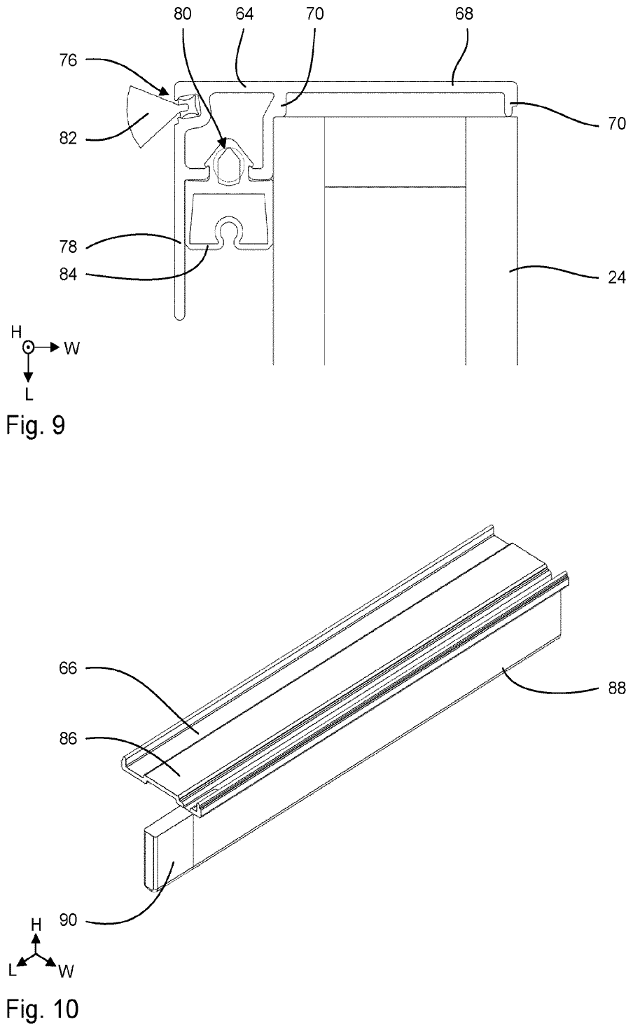

FIG. 9: shows a sectional view through the utility profile at the rear end face of the main component of the door leaf of FIG. 2, and

FIG. 10: shows a perspective view of a utility profile for the lower end face of the main component of the door leaf of FIG. 2.

FIG. 1 shows a door system 10 having a door header 12, at least one door leaf 14 according to the invention and a floor rail 16.

The door system 10 is in particular an automatic door system. The automatic door system 10 may be a door system mounted in a building to allow access to a building or to separate different areas within the building, e.g. shops, from one another. The door system may also be mounted in a vehicle, for example a ship or train.

The door system 10 and the door leaf 14 have a height direction H, a length direction L and a width direction W.

In the shown embodiment, the door system 10 is an automatic sliding door. In particular, the door system 10 may comprise two or more door leaves 14 even though only one door leaf 14 is shown.

The door leaf 14 is arranged below the door header 12 and is mounted movably with respect to the door header 12.

The floor rail 16 is fixed to the floor F below the door header 12 and extends mainly in the length direction L.

The door leaf 14 is movable in the length direction L along the floor rail 16 between a fully open position and a closed position.

In the fully open position, the door leaves 14 are located the furthest apart from one another, generating a passageway between the door leaves 14.

In the closed position, the door leaves 14 are closest to one another, in particular seals 74 (FIG. 8) of the door leaves 14 are in physical contact with one another.

The door header 12 comprises a controller 18 for controlling the motion of the door leaves 14, a sensor 20 detecting persons desiring to pass the door, and at least one drive unit 22.

The motion of the door leaf 14 along the floor rail 16 is carried out by the drive unit 22 in a fashion per se known in the art. In particular, for each door leaf 14 one drive unit 22 is provided.

In FIG. 2, the door leaf 14 is shown in an isometric view.

The door leaf 14 comprises a main component 24, a carrier profile 26, a strap 28 (FIG. 4), several spacers 35, 54, 58, 60 and several utility profiles 62, 64, 66.

The door leaf 14 is in particular free of a rigid frame encompassing the main component 24.

The main component 24 has a cuboid shape with an upper end face and a lower end face extending orthogonal to the height direction H as well as a front end face and a rear end face extending orthogonal to the length direction L.

The front end face corresponds to the main closing edge of the door leaf 14 and the rear end face corresponds to the secondary closing edge of the door leaf 14.

In the shown embodiment, the main component 24 is a glass element, in particular an insulating glass element. The glass element may have a width of at least 37 mm, in particular of 38 mm.

As known in the art, the glass element has a cavity filled with a gas, in particular Argon, to provide high thermal insulation.

At the upper end face, the carrier profile 26 is attached to the main component 24, as seen in the sectional view of FIG. 3.

An adhesive is located between the main component 24 and the carrier profile forming an adhesive connection 34, permanently fixating the carrier profile 26 to the main component 24.

The adhesive connection 34 may extend along the entire main component 24 and the length direction L and/or in the width direction W.

The adhesive is chosen such that the adhesive connection 34 is capable of carrying the whole weight of the main component 24 without further support.

The carrier profile 26 may be made of plastics or aluminum and extends along the entire length of the main component 24.

The carrier profile 26 is in particular fully located within the door header 12 so that it is not visible for the person passing the door, as illustrated in FIG. 1.

In the width direction W, the carrier profile 26 and the main component 24 have the same width. The carrier profile 26 is not wider than the main component 24 or encompasses the main component 24 in the width direction W.

FIG. 4 shows the front end face of the main component 24 and of the carrier profile 26 in an enlarged view. The strap 28 of the door leaf 14, the first spacer 35 as well as a tensioning mechanism 36 for the strap 28 are shown.

FIG. 5 shows the tensioning mechanism 36 without the main component 24 and the carrier profile 26 in more detail.

FIG. 6 shows the strap 28 fully, not showing the main component 24 and the carrier profile 26 for clarity.

The strap 28 comprises a first end 38 and a second end 40, wherein only the first end 38 is shown in FIGS. 4 and 5.

The strap 28 has a width smaller than the width of the main component 24, the carrier profile 26 and/or one, more or all of the spacers 35, 54, 58, 60.

The tensioning mechanism 36 comprises a spool 42 with engagement teeth 44, and the tensioning mechanism 36 further comprises a stop 46 for the engagement teeth 44.

The first spacer 35 comprises two protrusions 48 and a collar 50.

The collar 50 extends downward in front of the front end face of the carrier profile 26 as well as partly along the front end face of the main component 24.

The protrusions 48 are spaced apart in the width direction W and extend in the length direction L towards the rear.

The protrusions 48 are engaged with the carrier profile 26, for example in grooves 52 of the carrier profile 26.

The ends of the protrusions 48 facing away from the collar 50, i.e. facing the rear, are designed to receive the spool 42 and comprise the stops 46 for the engagement teeth 44.

The first end 38 of the strap 28 is inserted in the spool 42 and is thus attached to the carrier profile 26.

In the shown embodiment, the first spool 42 is arranged in the front quarter of the carrier profile 26, i.e. the quarter of the length of the carrier profile 26 abutting the front end face.

The spool 42 is rotatably mounted in the carrier profile 26 and also rotatably with respect to the first spacer 35. By turning the spool 42, the strap 28 may be tightened.

As can be seen in FIG. 6, the second spacer 54 is provided at the upper rear end face of the main component 24 and the carrier profile 26.

The second spacer 54 is designed in a mirrored fashion or identical to the first spacer 35. Further, a second spool 56 is provided and mounted to the carrier profile 26 as described with respect to the first spool 42 so that a second tensioning mechanism 36 is provided.

The second end 40 of the strap 28 may be engaged with the second spool 56 at the rear side of the door leaf 14.

The second spool 56 may be provided in the rear quarter of the carrier profile 26, i.e. the quarter of the length of the carrier profile 26 abutting the rear end face of the carrier profile 26.

Thus, the first end 38 of the strap 28 and the second end 40 of the strap are attached to the carrier profile 26 in its front quarter and rear quarter, respectively.

As shown in FIG. 6, the strap 28 extends from its first end 38 engaged with the first tensioning mechanism 36, i.e. the first spool 42, towards the front end face of the main component 24.

The strap 28 runs at the outside of the collar 50 of the first spacer 35 so that the first spacer 35 is located between the front end face of the main component 24 and the strap 28.

This strap 28 then runs along the front end face of the main component 24 spaced apart by a distance.

At the lower front end of the main component 24, i.e. the edge between the front end face and the lower end face, the third spacer 58 is provided as seen in FIG. 7.

The third spacer 58 has a first portion abutting the front end face of the main component 24 and a second portion abutting the lower end face of the main component 24. Thus, the third spacer 58 extends across the edge of the lower end face with the front end face.

The strap 28 extends on the outside of the third spacer 58, i.e. the side facing away from the main component 24 so that the third spacer 58 is located between the strap 28 and the main component 24.

The strap 28 then runs along the lower end face of the main component 24, also spaced apart by a distance.

At the lower rear end, i.e. the edge between the lower end face and the rear end face of the main component 24, the fourth spacer 60 is located.

The fourth spacer 60 is similar to the third spacer 58, but mirrored.

It has a first portion abutting the rear end face and a second portion abutting the lower end face of the main component 24. Thus, it extends across the edge of the lower end face with the rear end face of the main component 24.

Similarly to the third spacer 58, the strap 28 runs at the outer side of the fourth spacer 60, i.e. the side facing away from the main component 24.

The strap 28 then continues by running upwards in the height direction H along the rear end face of the main component 24, but spaced apart by a distance.

The strap 28 subsequently reaches the second spacer 54 and the strap 28 is then, with its second end 40, engaged in the second tensioning mechanism 36, i.e. the second spool 56.

The strap 28 thus also provides support for the main component 24 but, as explained above, the strap 28 may not be necessary to hold the main component 24 at the carrier profile 26.

The strap 28 is spaced apart from each of the end faces of the main component 24 due to the spacers 35, 54, 58, 60.

In the shown embodiment, three utility profiles are provided, namely a first utility profile 62, shown in FIG. 8, located at the front end face of the main component 24, a second utility profile 64, shown in FIG. 9, located at the rear end face of the main component 24 and a third utility profile 66, shown in FIG. 10, located at the lower end face of the main component 24.

The first and second utility profiles 62, 64 are very thin in the length direction L and the third utility profile 66 is very thin in the height direction capital H. Therefore, the utility profiles 62, 64, 66 are barely visible for a person passing the door.

The utility profiles 62, 64 and 66 may be made of plastics or aluminum and are not painted.

The utility profiles 62, 64 and 66 are attached directly to the main component 24 by an adhesive, forming further adhesive connections.

The width of the utility profiles 62, 64, 66 corresponds to the width of the main component 24, in particular, the utility profiles 62, 64, 66 do not encompass the main component 24 in the width direction W.

The utility profiles 62, 64 and 66 cover at least the whole end face of the main component 24 they are attached to.

In particular, the utility profiles 62, 64 and 66 do not form a frame for the main component 24 for supporting the main component 24. In fact, the utility profiles 62, 64 and 66 are supported by the main component 24.

The first utility profile 62 shown in FIG. 8 comprises a cover 68 and two ribs 70 at the ends of the cover 68 in the width direction W.

The ribs 70 abut the front end face of the main component 24 so that the cover 68 is spaced apart from the main component 24, forming a cavity. The cavity may be used for the adhesive.

The strap 28 extends between the cover 68 and the main component 24 so that it is not visible.

Further, the first utility profile 62 comprises two receptacles located at the side of the cover 68 facing away from the main component 24. The receptacles 72 may also be arranged at the ends of the cover 68 in the width direction W.

In each one of the receptacles 72, a seal 74 is inserted, in particular forming the main closing edge seal.

The cross-section of the first utility profile 62 is constant so that the receptacles 72 and also the seals 74 extend along the whole height of the main component 24.

The second utility profile 62 also comprises a cover 68 and ribs 70, to form a cavity used for the adhesive and/or for hiding the strap 28 from view.

In the width direction W, the second utility profile 62 extends beyond the main component 24 to one side.

The portion extending beyond the main component 24, i.e. the portion not in front of the rear end face of the main component 24, comprises a receptacle 76, a wing 78 and a mount 80.

The receptacle 76 is open in the width direction W, and a brush 82 or a seal is inserted. The brush 82 or seal extends in the width direction W.

The wing 78 extends in the length direction L and runs partly parallel to the main component 24 in the length direction L.

The mount 80 is located between the wing 78 and the main component 24 in the width direction W.

The mount 80 is designed to receive a seal 84 and the seal 84 is located in the mount 80.

As explained with respect to the first utility profile 62, the cross section of the second utility profile 64 is also constant in the height direction H.

The third utility profile 64, shown in FIG. 10, has a base portion 86 abutting the lower end face of the main component 24. The base portion 86 is located between the strap 28 and the main component 24.

The base portion 86 further comprises a protrusion extending in the height direction H downward, i.e. away from the main component 24. The protrusion forms part of a sword 88.

The protrusion forming the sword may be hollow so that an extension 90 in the length direction L can be inserted, which also forms part of the sword 88.

The extension 90 extends the sword 88 in the length direction L further than the base portion 86 so that the sword 88 is also located below the first utility profile 62.

The sword 88 engages with the floor rail 16 as indicated in FIG. 1.

The use of the adhesive connection 34 backed up by the strap 28 allow to manufacture a safe door leaf 14 with a long lifetime but without a frame. The door leaf 14 thus needs fewer material and may be assembled easily.

In addition, a main component with a larger width can be used compared to door leaves having a frame so that the insulation properties of the main component can be increased.

1. Door leaf for a door system (10) comprising a main component (24), a carrier profile (26) and a strap (28),
wherein the main component (24) has an upper end face, a front end face, a lower end face and a rear end face, wherein the carrier profile (26) is attached to the upper end face, and
wherein the strap (28) has a first end (38) and a second end (40), and the strap (28) is attached to the carrier profile (26) with the first end (38), subsequently extends along the front end face, the lower end face and the rear end face of the main component (24) and is subsequently attached to the carrier profile (26) with the second end (40).

2. Door leaf according to claim 1, characterized in that the main component (24) is attached to the carrier profile (26) by an adhesive connection (34), in particular wherein the adhesive connection (34) is capable of carrying the whole weight of the main component (24).

3. Door leaf according to claim 1, characterized in that the door leaf (14) comprises at least one tensioning mechanism (36) attached to the carrier profile (26), wherein the strap (28) is connected to the carrier profile (26) via the at least one tensioning mechanism (36).

4. Door leaf according to claim 3, characterized in that the tensioning mechanism (36) comprises a spool (42) in which the respective end (38, 40) of the strap (28) is inserted, in particular wherein the spool (42) has engagement teeth (44) for engaging with a stop (46) fixed relative to the carrier profile (26).

5. Door leaf according to claim 1, characterized in that the door leaf (14) comprises at least one spacer (35, 54, 58, 60) located between the strap (28) and one of the end faces of the main component (24).

6. Door leaf according to claim 5, characterized in that the at least one spacer (35, 54) is located at the front end face or the rear end face of the carrier profile (26) and extends downwards partly along the respective end face of the main component (24) and/or wherein the spacer (35, 54) is engaged with the carrier profile (26).

7. Door leaf according to claim 5, characterized in that the at least one spacer (58, 60) extends across the edge of the lower end face of the main component (24) with the front end face and/or with the rear end face of the main component (24), particularly the spacer (58, 60) abutting the respective end faces of the main component (24).

8. Door leaf according to claim 1, characterized in that the door leaf (14) comprises at least one utility profile (62, 64, 66), in particular three utility profiles (62, 64, 66), the at least one utility profile (62, 64, 66) being attached to the front end face, the lower end face or the rear end face of the main component (24), in particular by an adhesive connection.

9. Door leaf according to claim 8, characterized in that the utility profile (62) attached to the front end face comprises at least one receptacle (72) for receiving a seal (74) of the door leaf (14), in particular wherein the utility profile (62) comprises two receptacles (72), each for one seal (74).

10. Door leaf according to claim 8, characterized in that the utility profile (64) attached to the rear end face comprises a receptacle (76) for a brush (82) or seal facing in the width direction (W) and/or comprises a wing (78) extending in the length direction (L) partly along the main component (24).

11. Door leaf according to claim 8, characterized in that the utility profile (66) attached to the lower end face of the main component (24) comprises a sword (88) extending downward.

12. Door leaf according to claim 8, characterized in that the at least one utility profile (62, 64, 66) is made of plastics.

13. Door leaf according to claim 1, characterized in that the strap (28) has a smaller width than the main component (24) and/or in that the carrier profile (26) and/or utility profile (62, 64, 66) has the same width as the main component (24).

14. Door leaf according to claim 1, characterized in that the main component (24) is a glass element, in particular an insulating glass element.

15. Door system comprising a door leaf (14) according to claim 1, in particular wherein the door system (10) comprises a door header (12) and the carrier profile (26) is located in the door header (12), at least partly, in particular fully.
